(19) United States
(12) Patent Application Publication
(10) Pub. No.: US 2014/0143339 A1
(43) Pub. Date: May 22, 2014

(54) METHOD, APPARATUS, AND SYSTEM FOR RESOURCE SHARING

(71) Applicant: TENCENT TECHNOLOGY (SHENZHEN) COMPANY LIMITED, Shenzhen (CN)

(72) Inventors: YAN HUANG, Shenzhen (CN); YANG CAO, Shenzhen (CN)

(73) Assignee: TENCENT TECHNOLOGY (SHENZHEN) COMPANY LIMITED, Shenzhen (CN)

(21) Appl. No.: 14/163,078

(22) Filed: Jan. 24, 2014

Related U.S. Application Data
(63) Continuation of application No. PCT/CN2013/070933, filed on Jan. 24, 2013.

(30) Foreign Application Priority Data
Feb. 24, 2012 (CN) 201210043499.6

(51) Int. Cl. H04L 29/08

(52) U.S. Cl. CPC H04L 67/10
USPC 709/204

(57) ABSTRACT

Various embodiments provide methods, apparatus, and systems for resource sharing. In an exemplary method, sharing metadata can be generated based on information of a resource publisher and information of at least one sharing file by a publisher client terminal. The sharing metadata can be sent to a sharing server for the sharing server to generate a sharing link. The sharing link can be published by the sharing server. The sharing metadata can be obtained from the sharing server based on the sharing link corresponding to a requested resource by a downloading client terminal. The at least one sharing file instructed by the obtained sharing metadata can be downloaded by the downloading client terminal. One or multiple files can thus be shared via a single sharing link.

### CROSS-REFERENCES TO RELATED APPLICATIONS

This application is a continuation application of PCT Patent Application No. PCT/CN2013/070933, filed on Jan. 24, 2013, which claims priority to Chinese Patent Application No. CN201210043499.6, filed on Feb. 24, 2012, the entire contents of all of which are incorporated herein by reference.

### FIELD OF THE DISCLOSURE

The present disclosure relates to the field of network technology and, more particularly, relates to methods, apparatus, and systems for resource sharing.

### BACKGROUND

P2P (i.e., pear-to-pear or point-to-point) network technology often relies on computing capabilities and bandwidth of all participants in the network rather than on limited number of servers. By P2P network technology, a user may directly access computers of other users in the network to exchange file(s), with no need to browse and download file(s) via a server. While a user is downloading a file using a computer, this computer may simultaneously function as a host to upload the file. As a result, the more participants in the network, the faster the downloading speed can be. Compared with other network technologies, such P2P network technology allows online communications to be easier and more direct in sharing and exchanging file(s) without using intermediate service providers. Current file sharing schemes include ed2k (i.e., eDonkey 2000 network) based publishing and BT (i.e., BitTorrent) based downloading technologies.

A format for ed2k links is as follows: ed2k://|file|<file name>|<file size>|<file hash value>|/. This format is simple and users can use emule downloading tools (e.g., veryCD) to generate ed2k links from any local files and publish the ed2k links online. Other users may then use ed2k downloading tools to download the files corresponding to these ed2k links. Each local file is used to generate a different corresponding ed2k link and each ed2k link in turn corresponds to only one single file. Problems arise, however, because a single ed2k link is only used to share one file. If a user wants to share multiple files stored in a local computer, multiple ed2k links must be generated. This increases complexity in sharing file and receiving the shared files.

Conventional BT downloading technologies require downloading of a torrent file, followed by downloading contents of an original file corresponding to the torrent file using BT downloading software. The BT downloading software often automatically accesses a Tracker server according to a web address contained in the torrent file. The BT downloading software may also receive other nodes being downloaded from the Tracker server and obtain file segments from those other nodes until the downloading is completed.

A process for publishing torrent seeds by the BT downloading software is as follows. The BT downloading software may generally, by default, package some default Tracker addresses. Users may select a file or a file catalogue to publish. The BT downloading software calculates verification information of one or multiple files and combines the verification information with the Tracker addresses into a torrent file. The torrent file may be locally stored and published on line by users. Such publisher is often the only source in a beginning stage.

However, there are drawbacks regarding BT based publishing technologies. One of the drawbacks is that, because a torrent file contains verification information of file fragments, the resulting file often has a large size on an order of several K to several-hundred K. This significantly increases cost of transmission and publication. Another drawback is that, given the size of the torrent file, the torrent file often appears as a text file with a torrent suffix instead of a string. The torrent file contains non-standard code characters, which leads to poor identifiability, editability, and transmissibility.

Therefore, there is a need to solve these and other problems and to provide methods, apparatus, and systems for resource sharing with reduced complexity and reduced sharing cost.

### BRIEF SUMMARY OF THE DISCLOSURE

Various embodiments provide methods, apparatus, and systems for resource sharing such that one or multiple files can be shared via a single sharing link.

According to various embodiments, there is provided a resource sharing method. In this method, sharing metadata can be generated based on information of a resource publisher and information of at least one sharing file by a publisher client terminal. The sharing metadata can be sent to a sharing server for the sharing server to generate a sharing link. The sharing link can be published by the sharing server. The sharing metadata can be obtained from the sharing server based on the sharing link corresponding to a requested resource by a downloading client terminal. The at least one sharing file instructed by the obtained sharing metadata can be downloaded by the downloading client terminal.

According to various embodiments, there is also provided a client terminal apparatus including a resource sharing module and a resource requesting module. The resource sharing module can be configured, when publishing a sharing resource, to generate sharing metadata based on information of a resource publisher and information of at least one sharing file, and to send the sharing metadata to a sharing server for the sharing server to generate a sharing link from the sharing metadata, and to publish the sharing link. The resource requesting module can be configured, when requesting a resource, to obtain the sharing metadata from the sharing server corresponding to the requested resource, and to download the at least one sharing file instructed by the obtained sharing metadata.

According to various embodiments, there is further provided a server including a sharing link publishing module and an enquiry responding module. The sharing link publishing module can be configured to receive sharing metadata sent from a first client terminal, to generate a sharing link from the sharing metadata, to store a corresponding relationship between the sharing metadata and the sharing link, and to publish the sharing link. The sharing metadata can include information of a resource publisher and information of at least one sharing file. The enquiry responding module can be configured, after receiving a request from a second client terminal to request for an enquiry about the sharing metadata and according to the corresponding relationship between the sharing metadata and the sharing link stored in a storage module, to enquire about the sharing metadata corresponding to the sharing link requested for the enquiry, and to return the sharing metadata to the second client terminal.

In an exemplary embodiment, a publisher client terminal can consolidate information of a resource publisher and information of at least one sharing file to generate a sharing metadata for a sharing server to generate a sharing link. From the sharing link, other client terminals can obtain corresponding sharing metadata and download resources based on the sharing metadata. As such, a single sharing link can provide one or multiple files for sharing. This addresses problems that file(s) cannot be shared by an editable and identifiable link for sharing. Complexity of sharing file(s) can be simplified and sharing cost can be significantly reduced.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts network architecture for an exemplary system for sharing local file(s) in accordance with various disclosed embodiments;

FIG. 2 depicts a flow diagram of an exemplary method for resource sharing via a first client terminal in accordance with various disclosed embodiments;

FIG. 3 depicts a flow diagram of an exemplary method for requesting resource sharing via a second client terminal in accordance with various disclosed embodiments;

FIG. 4 depicts a structural diagram of an exemplary resource sharing server in accordance with various disclosed embodiments;

FIG. 5 depicts a structural diagram of an exemplary client terminal apparatus in accordance with various disclosed embodiments; and

FIG. 6 depicts a block diagram of an exemplary computer system in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

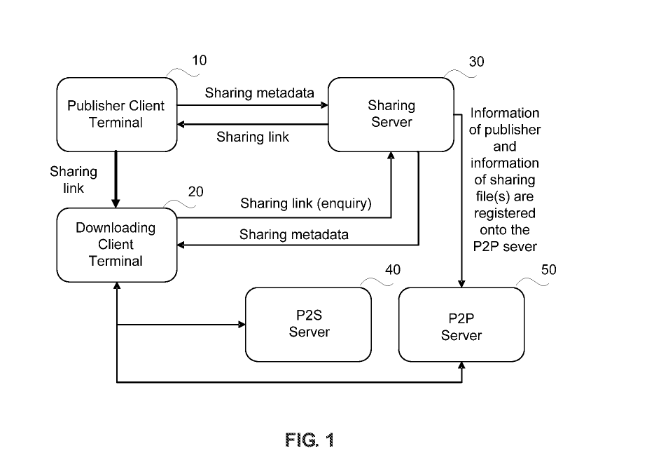

FIG. 1 depicts network architecture for an exemplary system for sharing local file(s) in accordance with various disclosed embodiments. As shown in FIG. 1, the exemplary system can include: a sharing server 30, a P2S (i.e., peer-to-server) server 40, a P2P server 50, and/or one or more client terminals. The client terminals can include, e.g., a publisher client terminal 10, a downloading client terminal 20, and/or other suitable client terminals. As used herein, the term “publisher” and “resource publisher” (or “publisher client terminal” and “resource publisher client terminal”) can be used interchangeably.

As disclosed herein, the sharing server 30 can be a server used to create and publish a sharing link (i.e., a link for sharing) based on sharing metadata sent from the publisher client terminal 10. A resource requesting client terminal or the downloading client terminal 20 can then obtain the sharing link and, thus the corresponding sharing metadata, to download resources based on the sharing metadata.

The P2S server 40 can be used to maintain and manage download sources on the server and provide resource downloading services to the client terminals. The P2P server 50 can be used to maintain and manage information of the publisher client terminal 10 used as the download sources. Such information may include an IP address and a connection port of the publisher client terminal 10. The P2P server 50 can provide information of the download sources to the downloading client terminal 20.

In one embodiment, metadata can be generated by the (resource) publisher client terminal 10 and can include information of the publisher and information of sharing file(s) (e.g., file(s) for sharing). The sharing file(s) can be at least one, for example, about two or more, to provide good performance in accordance with various embodiments. In this manner, a single short text string download link can be provided to, e.g., multiple sharing files.

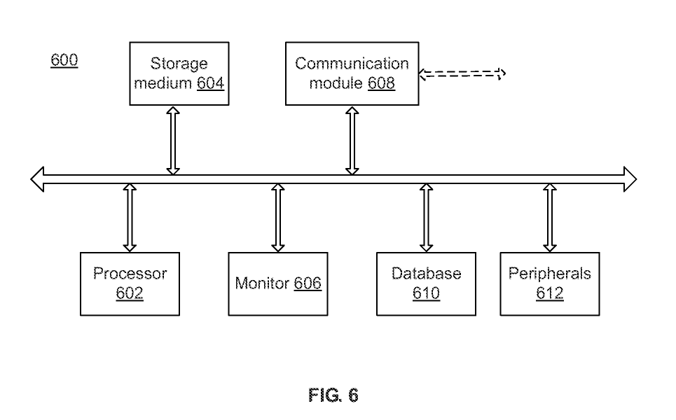

The various systems depicted in FIG. 1, such as publisher client terminal 10, downloading client terminal 20, sharing server 30, P2S server 40, and/or P2P server 50, may be implemented on any appropriate computing platform. FIG. 6 shows a block diagram of an exemplary computer system 600 capable of implementing the various systems depicted in FIG. 1 for sharing resources, files, data, etc.

As shown in FIG. 6, computer system 600 may include a processor 602, a storage medium 604, a monitor 606, a communication module 608, a database 610, and peripherals 612. Certain devices may be omitted and other devices may be further included.

Processor 602 may include any appropriate processor or processors. Further, processor 602 can include multiple cores for multi-thread or parallel processing. Storage medium 604 may include memory modules, such as ROM, RAM, and flash memory modules, and mass storages, such as CD-ROM, U-disk, hard disk, etc. Storage medium 604 may store computer programs for implementing various processes, when executed by processor 602.

Further, peripherals 612 may include I/O devices such as keyboard and mouse, and communication module 608 may include network devices for establishing connections through a wireless or wired communication network. Database 610 may include one or more databases for storing certain data and for performing certain operations on the stored data, such as database searching.

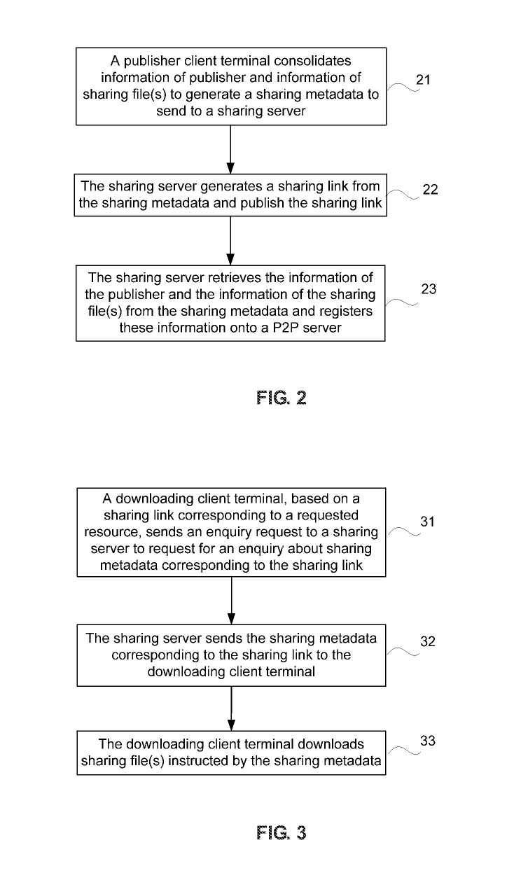

During operation, the various systems (e.g., the system 600) as illustrated in FIG. 1 can perform various processes for resource sharing and data exchange. For example, FIGS. 1-2 depict an exemplary resource sharing method via a publisher client terminal.

In Step 21 of FIG. 2 and referring to FIG. 1, the publisher client terminal 10 may consolidate information of the publisher and information of one or more sharing file(s) to generate sharing metadata. The sharing metadata can then be sent to the sharing server 30.

In one embodiment, the sharing metadata can include information of the publisher and file identification of each of the sharing file(s). In various embodiments, the sharing metadata can also include a file title and a file size of each of the sharing file(s), and/or number of the sharing file(s). For example, when the publisher client terminal 10 intends to share N (e.g., an integer or number, as desired) local files, e.g., Filet, File2, . . . and fileN, their file names can respectively be Name1, Name2, . . . and NameN. The publisher client terminal 10 can obtain file size of each of these N files and calculate file identification of each of these N files. The file identification may be used to uniquely identify the file.

For example, the file size of these N files can be Size1, Size2, . . . and SizeN, respectively. The file identification of these N files can be calculated as Hash1, Hash2, . . . and HashN. That is, the file identification can be calculated using a hash algorithm based on file contents. In one embodiment, the publisher client terminal 10 may use any suitable algorithms, such as MD5 (i.e., message digest algorithm 5), SHA1 (i.e., secure hash algorithm 1), or SHA2, to calculate a hash value of the contents of the sharing file to obtain the file identification of the sharing file.

In various embodiments, the publisher client terminal 10 can consolidate multiple sharing files using the following format to obtain, e.g., sharing metaData:

metaData={Publisherinfo, FileNum, memo, (FileInfo1, FileInfo2, FileInfoN)};

where FileInfoi={Namei, Sizei, Hashi} and i=1, 2, . . . N; Publisherinfo denotes information of the publisher including the IP address and connectable ports of the publisher client terminal; FileNum denotes number of the sharing files; memo denotes file abstract, e.g., which may be left blank or may include readable contents written by allowed users when sharing the files; and FileInfo denotes information of the sharing files including, e.g., title, size, and identification of the files for sharing.

In Step 22 of FIG. 2 and referring to FIG. 1, the sharing server 30 can generate a sharing link based on the sharing metadata and then publish the sharing link. For example, the sharing server 30 can compute the sharing metaData using a hash algorithm to generate a sharing link (e.g., Hash_metaData) and then publish the sharing link (e.g., Hash_metaData). In one embodiment, the sharing server 30 can publish the sharing link (e.g., Hash_metaData) and related information of the sharing file(s) onto sharing site(s) for clients to download.

In Step 23 of FIG. 2 and referring to FIG. 1, information of the publisher and information of the sharing file(s) can be extracted from the sharing metadata by the sharing server 30 and registered onto the P2P server 50. For example, Publisherinfo and FileInfo can be extracted by the sharing server 30 from the sharing metaData and then registered onto the P2P server 50. The Publisherinfo can include the IP address and connectable ports of the publisher client terminal 10, and other suitable information. When other client terminals (e.g., the downloading client terminal 20 in FIG. 1) need to download files from the sharing metadata, the other clients can obtain Publisherinfo from the P2P server 50 and to download the file(s) from the publisher client terminal 10.

After a sharing link is generated, the sharing server 30 can send the sharing link to the corresponding publisher client terminal 10 such that the publisher client terminal 10 can send the sharing link to other client terminals for other client terminals to download related resources. As the sharing link (e.g., Hash_metaData) is a text string as disclosed herein, the downloading client terminal 20 can obtain the sharing link sent from the publisher client terminal 10, e.g., via E-mails, QQ tools, MSN tools, and/or any other suitable network tools.

Note that the sequence of events depicted in FIG. 2, e.g., Steps 22 and 23, is not intended to be limited in accordance with various embodiments. For example, Step 23 can be performed before Step 22 or the two Steps 22-23 can be performed at the same time.

As such, a sharing resource can include, e.g., information of the resource publisher and information of the one or more sharing files. After the sharing resource is published by the sharing server 30 via the sharing link as depicted in FIGS. 1-2, the sharing resource can be requested by the downloading client terminal 20 to download the one or more sharing files. For example, FIGS. 1 and 3 depict an exemplary method for requesting resource sharing in accordance with various embodiments.

In Step 31 of FIG. 3 and referring to FIG. 1, when requesting the sharing resource, the downloading client terminal 20 (or a resource requesting client terminal) can follow the sharing link (e.g., Hash-metaData) corresponding to the requested resources.

The downloading client terminal 20 can send a request for an enquiry to the sharing server 30 and request the enquiry about sharing metadata corresponding to the sharing link, which corresponds to the requested resources. In various embodiments, the downloading client terminal 20 may receive the sharing link sent from the publisher client terminal 10 or may select a sharing link from resource sharing sites.

In Step 32 of FIG. 3 and referring to FIG. 1, the sharing server 30 can provide feedback of the sharing metadata corresponding to the sharing link to the downloading client terminal 20. According to a corresponding relationship between the sharing metadata and the sharing link stored in the sharing server 30, the sharing server 30 can obtain the sharing metadata corresponding to the sharing link requested by the downloading client terminal 20, and return the sharing metadata to the downloading client terminal 20.

In Step 33 of FIG. 3 and referring to FIG. 1, the downloading client terminal 20 can download the sharing file(s) according to instructions contained in the sharing metadata. For example, after receiving the sharing metadata, the downloading client terminal 20 can know information of a first publisher (e.g., including IP address and connectable port) and information of each of the sharing file(s), and/or other suitable information, contained in the sharing metadata.

According to the sharing link, the downloading client terminal 20 can then enquire about download sources of corresponding file(s) from the P2S server 40 and/or P2P server 50. For example, the downloading client terminal 20 may enquire about whether current network includes a server that provides download services for the corresponding file(s) or whether other client terminals are downloading corresponding file(s). Once download sources of corresponding file(s) are enquired, the downloading client terminal 20 can download corresponding file(s) from the download sources.

As disclosed, the sharing server 30 can register information of the publisher and information of corresponding sharing file(s) onto the P2P server 50. When a publisher client terminal 10 is online at this time, the publisher client terminal 10 can become the first data node in the P2P network and provide downloading data to the downloading client terminal 20.

When downloading the file(s), the downloading client terminal 20 may register its own information (e.g., IP address and connectable port) onto the P2P server 50. When other client terminals intend to download these file(s), the other client terminals can find those registered client terminals from the P2P server 50. These registered client terminals can provide corresponding file(s) to achieve multiple-point simultaneous downloading.

In this manner, a publisher client terminal can consolidate information of the publisher and information of multiple (and/or one) sharing files to create a sharing metadata for a sharing server to generate a sharing link (e.g., Hash-metaData). From the sharing link, other client terminals can obtain corresponding sharing metadata and enquire about a network element for downloading the sharing metadata file from a P2P server and/or a P2S server and then download from the network element. As such, a single sharing link can be used to share multiple files. This addresses problems that multiple files cannot be shared by an editable and identifiable link for sharing. Complexity for sharing multiple files can be simplified and sharing cost can be significantly reduced.

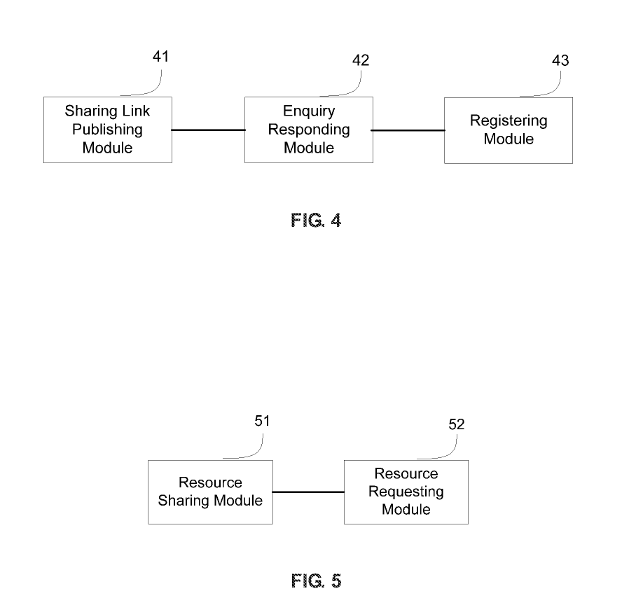

FIG. 4 depicts an exemplary sharing server in accordance with various disclosed embodiments. As shown, the sharing server can include a sharing link publishing module 41, an enquiry responding module 42, and/or a registering module 43.

The sharing link publishing module 41 can be used to receive sharing metadata sent by a resource publisher client terminal and generate a sharing link from the sharing metadata. The sharing link publishing module 41 can also store a corresponding relationship between sharing metadata and sharing links and publish the sharing link. The sharing metadata may include information of the resource publisher and information of at least one sharing file. In one embodiment, the sharing link publishing module 41 can be used to compute the sharing metadata, e.g., using a hash algorithm, to obtain a sharing link.

The enquiry responding module 42 can be used, e.g., after receiving a request from a (resource) requesting client terminal to request for an enquiry on sharing metadata, based on the corresponding relationship between sharing metadata and sharing links (e.g., stored in a storing module in the sharing link publishing module 41), to enquire about the sharing metadata corresponding to the sharing link requested for the enquiry. The enquiry responding module 42 can then provide feedback to the resource requesting client terminal. The sharing metadata can be returned to the resource requesting client terminal.

The sharing server can further include the registering module 43. After receiving the sharing metadata sent by the (resource) publisher client terminal, the registering module 43 can be used to register the information of the resource publisher and information of the sharing file(s) contained in the sharing metadata onto a P2P server.

FIG. 5 depicts an exemplary client terminal apparatus in accordance with various disclosed embodiments. As shown, the client terminal apparatus can include a resource sharing module 51 and a resource requesting module 52.

The resource sharing module 51 can be used, e.g., when the exemplary client terminal is used as a resource publisher client terminal, to generate sharing metadata based on information of the resource publisher and information of at least one sharing file and to send the sharing metadata to a sharing server such that the sharing server can generate a sharing link from the sharing metadata and publish the sharing link.

In one embodiment, the sharing metadata generated by the resource sharing module 51 can include information of the resource publisher and information of each of the sharing file(s). Information of each sharing file can include, e.g., file identification. The resource sharing module 51 can be used to compute contents of the sharing file(s), e.g., using a message digest algorithm or a secure hash algorithm, to obtain information of the sharing file(s). The resource sharing module 51 can be used to compute the sharing metadata, e.g., using a hash algorithm, to generate a sharing link.

The resource requesting module 52 can be used, e.g., when the exemplary client terminal is used as a resource requesting client terminal, to obtain sharing metadata from the sharing server based on corresponding requested resources and to download sharing file(s) according to instructions contained in the sharing metadata. After receiving the sharing metadata, the sharing server can register information of the resource publisher and information of the sharing file(s) contained in the sharing metadata onto a P2P server.

The resource requesting module 52 can also be used, e.g., before downloading the sharing file(s), to enquire about a P2P server and/or a P2S server for download sources having the sharing file(s) therein. In addition, when downloading the sharing file(s), the resource requesting module 52 can register its own information onto the P2P server.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

The disclosed embodiments (e.g., as shown in FIGS. 1-6) are examples only. One of ordinary skill in the art would appreciate that suitable software and/or hardware (e.g., a universal hardware platform) may be included and used in accordance with various disclosed embodiments. For example, the disclosed embodiments can be implemented by hardware only, which alternatively can be implemented by software products only. The software products can be stored in a storage medium. The software products can include suitable commands to enable a terminal device (e.g., including a mobile phone, a personal computer, a server, or a network device, etc.) to implement the disclosed embodiments.

Other applications, advantages, alternations, modifications, or equivalents to the disclosed embodiments are obvious to those skilled in the art.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods, apparatus, and systems for resource sharing can allow one or multiple files to be shared via a single sharing link. For example, a publisher client terminal can consolidate information of the publisher and information of the one or multiple sharing files to generate a sharing metadata for a sharing server to generate a sharing link. From this sharing link, other client terminals can obtain corresponding sharing metadata and download resources based on the sharing metadata. As such, a single sharing link can provide one or multiple files for sharing. This addresses problems that file(s) cannot be shared by an editable and identifiable link for sharing. Complexity for sharing file(s) can be simplified and sharing cost can be significantly reduced.

What is claimed is:

1. A method for resource sharing comprising:
generating sharing metadata based on information of a resource publisher and information of at least one sharing file by a publisher client terminal;
sending the sharing metadata, by the publisher client terminal, to a sharing server for the sharing server to generate a sharing link;
publishing the sharing link by the sharing server;
obtaining the sharing metadata from the sharing server based on the sharing link corresponding to a requested resource by a downloading client terminal; and
downloading the at least one sharing file instructed by the obtained sharing metadata by the downloading client terminal.

2. The method of claim 1, wherein:
after receiving the sharing metadata, the sharing server registers the information of the resource publisher and the information of the at least one sharing file contained in the sharing metadata onto a P2P server;
prior to downloading the at least one sharing file by a client terminal, the client terminal enquires about a download source including the at least one sharing file from one or more of the P2P server and a P2S server; and
when downloading the at least one sharing file, the client terminal registers information thereof onto the P2P server.

3. The method of claim 1, further including generating the sharing metadata based on the information of the resource publisher and the information of at least two sharing files.

4. The method of claim 1, wherein the sharing metadata include the information of the resource publisher and the information of each sharing file of the at least one sharing file, and wherein the information of the at least one sharing file includes a file identification.

5. The method of claim 4, wherein the sharing metadata further include information of number and abstract of the at least one sharing file.

6. The method of claim 4, wherein the information of the each sharing file further includes a file name and a file size of the each sharing file.

7. The method of claim 4, wherein the file identification is obtained by computing content of the each sharing file via a message digest algorithm or a secure hash algorithm.

8. The method of claim 1, wherein the information of the resource publisher includes an IP and a connectable port of the resource publisher.

9. The method of claim 1, wherein the sharing server computes the sharing metadata using a hash algorithm to generate the sharing link and to publish the sharing link.

10. A client terminal apparatus comprising:
a resource sharing module and a resource requesting module, wherein:
the resource sharing module is configured to generate sharing metadata based on information of a resource publisher and information of at least one sharing file, and to send the sharing metadata to a sharing server for the sharing server to generate a sharing link from the sharing metadata and to publish the sharing link; and
the resource requesting module is configured to obtain the sharing metadata from the sharing server corresponding to the requested resource, and to download the at least one sharing file instructed by the obtained sharing metadata.

11. The apparatus of claim 10, wherein the resource requesting module is configured to further enquire about a download source, having the at least one sharing file therein, from one or more of a P2P server and a P2S server, prior to downloading the at least one sharing file.

12. A sharing server comprising:
a sharing link publishing module configured to receive sharing metadata sent from a first client terminal, to generate a sharing link from the sharing metadata, to store a corresponding relationship between the sharing metadata and the sharing link, and to publish the sharing link, wherein the sharing metadata include information of a resource publisher and information of at least one sharing file; and
an enquiry responding module configured, after receiving a request from a second client terminal to request for an enquiry about the sharing metadata and according to the corresponding relationship between the sharing metadata and the sharing link stored in a storage module, to enquire about the sharing metadata corresponding to the sharing link requested for the enquiry, and to return the sharing metadata to the second client terminal.

13. The server of claim 12, further including:
a registering module configured, after receiving the sharing metadata sent by the first client terminal, to register the information of the resource publisher and the information of the at least one sharing file contained in the sharing metadata onto a P2P server.
